(19) United States
(12) Patent Application Publication
(10) Pub. No.: US 2005/0177616 A1
(43) Pub. Date: Aug. 11, 2005

(54) Method and system for distributing services in a digital asset environment

(75) Inventors: Timothy H. Addington, Roswell, GA (US); Stephen Berger, Norcross, GA (US); Darryl DeFreese, Lawrenceville, GA (US)

Correspondence Address: KING & SPALDING LLP, 191 PEACHTREE STREET, N.E., 45TH FLOOR, ATLANTA, GA, 30303-1763, US

(73) Assignee: N2 Broadband, Inc., Duluth, GA (US)

(21) Appl. No.: 10/741,605

(22) Filed: Dec. 19, 2003

(51) Int. Cl. G06F 15/16

(52) U.S. Cl. 709/203

(57) ABSTRACT

In a system for managing and selecting a service to fulfill a request, a client application can issue a message to execute a function. A service proxy can receive the message from the client application and identify one of a plurality of services to execute the function in accordance with one or more rules. Upon identifying the service to execute the function in accordance with the rules, the service proxy can send a message to the identified service to execute the function. Alternatively, the service proxy can send the identity of the identified service to the client application. The client application can then send the message to execute the function to the identified service upon receiving the identity of the identified service from the service proxy.

### FIELD OF THE INVENTION

The present invention is generally directed to cable television networks. More particularly described, the present invention supports the selection of a service to fulfill a request through the use of a service proxy and a service proxy rules engine to determine which service should be used.

### BACKGROUND OF THE INVENTION

Up until recently, conventional cable television systems have typically been proprietary, single-vendor systems. In such cable television systems, the addition or integration of a new system component or service necessitates the customization of software code or hardware to integrate each new component or service. As a result, such systems are not easily scalable and are expensive to modify or expand.

Industry system standards, such as Interactive Services Architecture (“ISA”), have improved the scalability of cable television systems and have enabled “plug and play” interoperability of multi-vendor components and services. In the exemplary multi-vendor system 10 illustrated in FIG. 1, one or more multi-vendor movie on demand (“MOD”) applications 100₁, 100₂, 100₃ can interact with one or more multi-vendor MOD services 120_{A}, 120_{B} using a system standard, such as ISA. For example, an MOD application 100₁ can stream a movie to a requesting subscriber through an MOD service 120_{A} provided by another vendor.

In the conventional art, each MOD service 120_{A}, 120_{B} may service a particular set of subscribers or overlapping sets of subscribers. Additionally, each MOD service 120_{A}, 120_{B} may service subscribers located in a particular geographic area or may service subscribers of a particular demographic. For example, as illustrated in FIG. 1, MOD service 120_{A} services subscribers located in geographic areas 1, 2, and 3, and MOD service 120_{B} services subscribers located in geographic areas 1 and 2.

Each MOD application 100₁, 100₂, 100₃ uses a set of rules or business logic 130₁, 130₂, 130₃ to determine which MOD service 120_{A}, 120_{B} to use to stream a movie to a particular subscriber. For example, the MOD application 100₁, 100₂, 100₃ may use business logic 130₁, 130₂, 130₃ to determine which MOD service 120_{A}, 120_{B} is available, which MOD service 120_{A}, 120_{B} is physically located closest to the requesting subscriber, or which MOD service 120_{A}, 120_{B} is the least expensive for the MOD application 100₁, 100₂, 100₃ to use.

Despite its advantages over conventional proprietary cable television systems, the conventional multi-vendor system 10 of FIG. 1 nonetheless has several limitations. First, such a system 10 is not easily expandable or scalable. For example, if the system 10 needs to integrate an additional MOD service 120_{C} to support the demand of its subscribers in geographic area 3, then each MOD application 100₁, 100₂, 100₃ and its corresponding business logic 130₁, 130₂, 130₃ would need to be modified in order to recognize and support the new MOD service 120_{C}.

Another limitation of such a system 10 is that each MOD application 100₁, 100₂, 100₃ may implement different business rules or business logic 130₁, 130₂, 130₃ in determining which MOD service 120_{A}, 120_{B}, 120_{C} to use to stream a movie to a subscriber. Although each MOD application 100₁, 100₂, 100₃ could coordinate the streaming of movies in order to ensure that the MOD services 120_{A}, 120_{B}, 120_{C} are being used efficiently, such an approach precludes the dynamic streaming of movies to subscribers. Additionally, the required coordination between multiple MOD applications 100₁, 100₂, 100₃ creates inherent complexities in allocating resources, it makes the streaming of movies to subscribers extremely difficult to manage, and the result may not make the most efficient use of the system's resources.

Accordingly, there is a need in the art for a system and method for easily scaling a cable television system to meet the needs of cable subscribers. Additionally, there is a need in the art for a system and method for easily and efficiently integrating multi-vendor applications and services in a cable television system without significant engineering effort or expense. Finally, there is a need in the art for an efficient system and method for allocating system resources among multi-vendor components that minimize manual intervention and promote the efficient use of each resource.

### SUMMARY OF THE INVENTION

The present invention can solve the aforementioned problems by providing a system and method for managing and selecting a service to fulfill a request. In one aspect of the present invention, a client application can issue a message to execute a function. A service proxy can receive the message from the client application and identify one of a plurality of services to execute the function in accordance with one or more rules. In one aspect of the present invention, upon identifying the service to execute the function in accordance with the rules, the service proxy can send a message to the identified service to execute the function. In another aspect of the present invention, the service proxy can send the identity of the identified service to the client application. The client application can then send the message to execute the function to the identified service upon receiving the identity of the identified service from the service proxy.

Various aspects of the present invention may be more clearly understood and appreciated from a review of the following detailed description of the disclosed embodiments and by reference to the drawings and claims.

### BRIEF DESCRIPTION OF DRAWINGS

FIG. 1 illustrates components of a conventional cable television system.

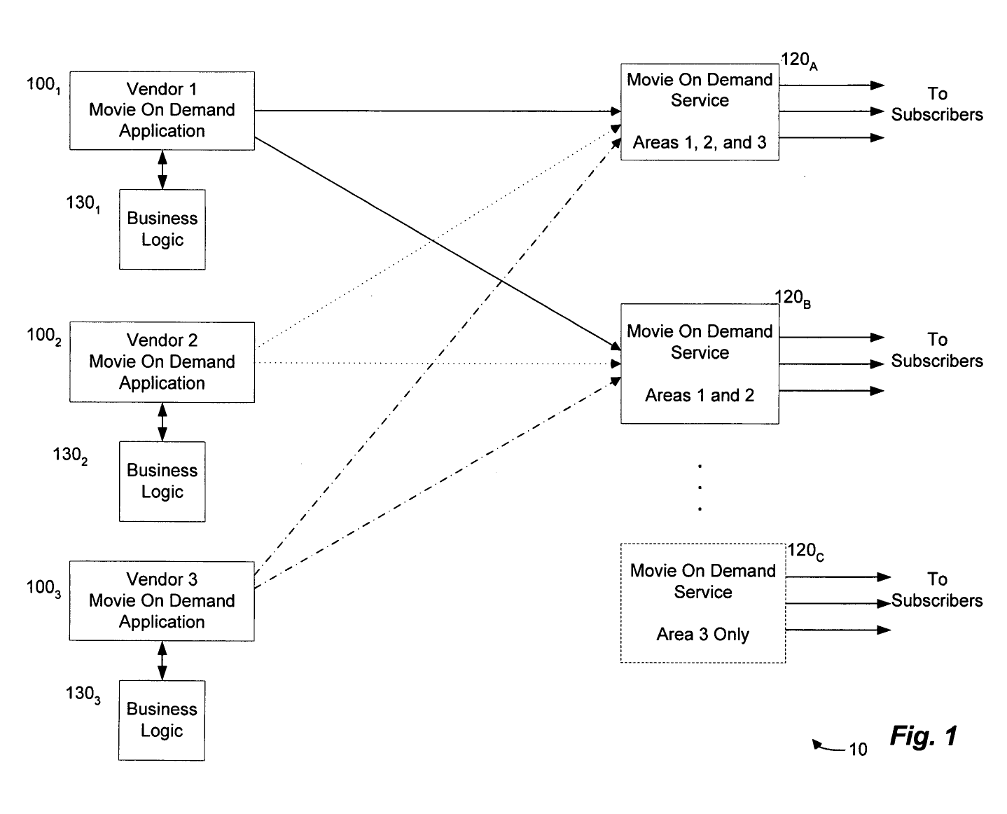

FIG. 2 illustrates components of an exemplary system for streaming a service to one or more subscribers.

FIG. 3 is a block diagram illustrating an exemplary system for streaming movies to a cable subscriber using a service proxy.

FIG. 4 is a block diagram illustrating an exemplary process by which the rules engine selects which movie on demand service should be used upon executing an exemplary ServiceProxyRule.

FIG. 5 is a logic flow diagram illustrating an exemplary process for streaming a movie to a cable subscriber using a service proxy.

FIG. 6 is a logic flow diagram illustrating another exemplary process for streaming a service to a cable subscriber.

### DETAILED DESCRIPTION OF EXEMPLARY EMBODIMENTS

Although the illustrative embodiments will be generally described in the context of the cable television industry, those skilled in the art will recognize that other exemplary embodiments of the present invention may be implemented for any application in which it is necessary to determine which service should be selected and used to fulfill a request for a particular service.

In one exemplary embodiment of the present invention, a subscriber can request to receive a service offered by the system. An exemplary client application can send a message to an exemplary service proxy informing the service proxy that a service has been requested. The service proxy can use an exemplary rules engine to determine which of a plurality of services should be used to fulfill the subscriber's request. Upon determining which service should be used to fulfill the request in accordance with one or more exemplary rules executed by the rules engine, the service proxy can send a message to the selected service to fulfill the request.

In another exemplary embodiment of the present invention, a subscriber can request to receive a service offered by the system. An exemplary client application can send a message to an exemplary service proxy informing the service proxy that a service has been requested. The service proxy can use an exemplary rules engine to determine which of a plurality of services should be used to fulfill the subscriber's request. Upon determining which service should be used to fulfill the request in accordance with one or more exemplary rules executed by the rules engine, the service proxy can send a message to the client application identifying which service should be used. The client application can then send a message to the selected service to fulfill the request.

Referring now to the drawings in which like numerals represent like elements throughout the several figures, exemplary embodiments of the present invention and the illustrative operating environment will be described in connection with the drawings.

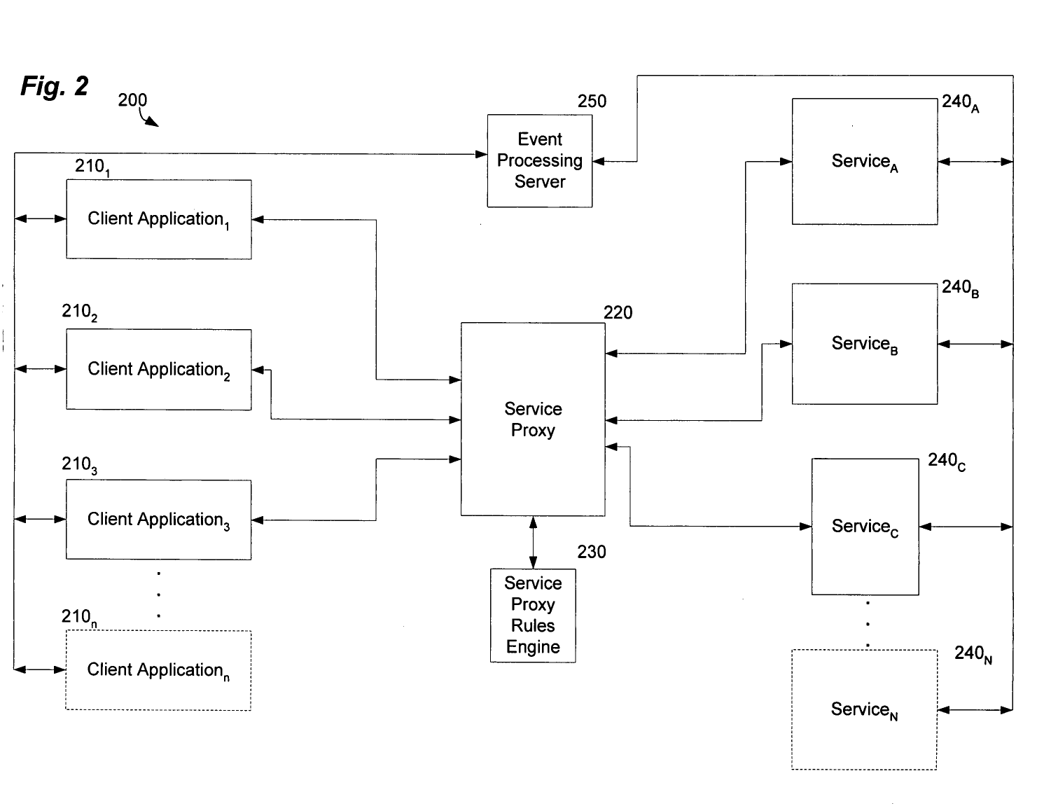

FIG. 2 illustrates components of an exemplary system 200 for streaming a service to one or more subscribers. The system 200 comprises one or more client applications 210₁, 210₂, 210₃ . . . 210ₙ. The client applications 210₁, 210₂, 210₃ . . . 210ₙ can be provided by one or more vendors.

The system 200 further comprises one or more services 240_{A}, 240_{B}, 240_{C} . . . 240_{N}. The services 240_{A}, 240_{B}, 240_{C} . . . 240_{N} can fulfill a request issued by a client application 210₁, 210₂, 210₃ . . . 210ₙ.

The system 200 also comprises a service proxy 220. The service proxy 220 utilizes a service proxy rules engine (“rules engine”) 230. The rules engine 230 uses business logic or “rules” to determine which service 240_{A}, 240_{B}, 240_{C} . . . 240_{N} should be utilized to stream a service from a client application 210₁, 210₂, 210₃, 210ₙ to a particular subscriber. For example, the service proxy 220 uses the rules engine 230 to determine which service 240_{A}, 240_{B}, 240_{C} . . . 240_{N} is the cheapest option, which service 240_{A}, 240_{B}, 240_{C} . . . 240_{N} is available, or which service 240_{A}, 240_{B}, 240_{C} . . . 240_{N} is in the closest proximity to a particular subscriber.

The service proxy 220 uses the rules engine 230 to make decisions based on a variety of factors within the system 200. Since the system 200 is architected to be extremely flexible and to support future hardware and service offerings, the rules engine 230 defines a dialog without specifying an actual implementation. As new services and hardware are added, they may be added into the rules engine 230 with little or no changes to the rules engine 230 itself.

The rules engine 230 supports abstract references to objects, verbs, and events. In one exemplary embodiment, the form of a rule comprises “If object meets these criteria, then perform this verb on an object.” In another exemplary embodiment, the form of the rule comprises “If event is received then perform this verb on an object.” In yet another exemplary embodiment, complex rules can also be created, such as “If an event is received and object(event) meets these criteria then perform verb on object(matching criteria).”

By using abstract references to objects, verbs, and events, the rules engine 230 can perform a variety of tasks. For example, using the aforementioned exemplary rules, a rules engine 230 can be implemented to remove expired files from a movie on demand service 240 using the following exemplary rule: “If TimerObject(HourEvent) then MODServer(DeleteContent(Expired)).”

In one exemplary embodiment, rules are expressed as XML documents. For example, for the preceding exemplary rule to remove expired files from a movie on demand service 240, the XML document could be expressed as:

<?xml version=“1.0”?>
<!DOCTYPE ServiceProxyRule SYSTEM
“http://svcproxy/xmldb/svcproxyrule.dtd”>
<ServiceProxyRule>

Name=“ExpireContentRule”
<Event

Object=“Timer”
Event=“HourEvent”

</Event>
<Action

Object=“AllMODServers”
Criteria=“FindContent(Expired)”
Verb=“DeleteContent”

</Action>
<Action>

ThrowEvent=“ExpireContentRule”

</Action>

</ServiceProxyRule>

In the ExpireContentRule example above, the HourEvent event is “thrown” from a Timer object to initiate the rule. In other words, a Timer object issues an event message pertaining to the HourEvent event. Any process interested in being notified when such an event occurs registers to be notified when the event message has been issued.

More particularly described, the system 200 comprises an event processing server 250. The event processing server 250 is located at a well known address on the network. The event processing server 250 manages a list of event types. In one exemplary embodiment, these event types are configured by a system administrator. In another exemplary embodiment, these event types are automatically added by software processes.

All software processes in the system 200 are able to send event messages to the event processing server 250 at any time. The event message comprises an event type and any additional information pertaining to that event type. In one exemplary embodiment, an event may be “Timer” and the event may contain a timerId and timerStatus field. The timerId would identify a particular timer, such as “Watchdog Timer,” and the timerStatus would identify the reason the event was thrown, such as “Time Expired.”

All software processes are also able to register with the event processing server 250 to receive event messages. In one exemplary embodiment, the registration may comprise additional filter criteria. For instance, a process may register to receive “Timer” events when the timerId field comprises “Watchdog Timer.” When the event processing server 250 receives a timer event with the timerId field matching “Watchdog Timer,” it would send timer events to all processes that had registered for “Timer” events and whose event criteria matched the “Watchdog Timer” timerId.

When an HourEvent from the Timer object is received by the rules engine 230, the rules engine 230 processes the list of actions for the rule in order. Thus, in the above exemplary rule, the first action is taken on the group defined as AllMODServers. The rules engine 230 executes the FindContent verb on each movie on demand service object 240 in the group using the criteria Expired. For every content object that matches the Expired criteria, the DeleteContent verb is executed. After all movie on demand services 240 have been processed, the rules engine 230 executes the second action.

The second action throws an ExpireContentRule event from the rules engine 230. The ExpireContentRule event is used to inform any registered process that this rule has been executed on the affected content. Any processes interested in that content would use this event to trigger any processing it needs to do in response to the change in content status. For example, in one exemplary embodiment, a catalog process may remove the content from a catalog that displays available content to a user.

Other processes in the system 200 may monitor this event and use it to initiate other actions, such as logging or updating a catalog. It should also be noted that the MODServer object may also throw events on each content object as they are deleted.

Objects

An object can be used to describe a component of the system 200. Exemplary objects in a cable system comprise movie on demand services, video services, encoders, switches, and multiplexers. However, those skilled in the art recognize that objects can also refer to software modules and files as well. In one exemplary embodiment, a selection of video content can be an object as well as a file containing the metadata for that content.

Each object has a set of criteria against which it can be tested. Each object also has a set of verbs that may be performed on the object. These verbs are operations that the rules engine 230 can execute against that object. When an object is defined in the rules engine 230, the verbs that are supported by that object are also defined. The rules engine 230 performs operations on an object by executing these verbs. When the rules engine 230 executes a verb on an object, it may pass that object a list of other objects that it uses to perform the verb.

Verbs

Verbs can be associated with actions that are recognized by the rules engine 230. For instance, in the case of a movie on demand service object 240, the rules engine 230 may support verbs such as: AddContent(objectId), DeleteContent(objectId), and FindContent(objectId). These verbs allow the service proxy 220 to manage content on the movie on demand service 240. As is understood by those skilled in the art, other verbs may allow the service proxy 220 to play content or obtain the status and configuration of the movie on demand service 240.

Objects may also define a set of events that the object is capable of producing. These events are sent to the service proxy 220 in response to an activity that has taken place in the object. The service proxy 220 may use these events to manage that object or other objects in the system 200.

In one exemplary embodiment of the present invention, objects are defined using Extensible Markup Language (XML) documents. As is understood by those skilled in the art, XML documents use a tag/value mechanism to describe the object. In order to provide future flexibility, an object definition may be extended by adding additional tag/value descriptors. Backwards compatibility is maintained by requiring that an object maintain existing functionality with current service proxy 220 implementations that do not recognize newer descriptors. A service proxy 220 implementation will ignore any descriptors that it does not recognize. This allows a situation where new features may be added to an object, and that object will work on multiple versions of the service proxy 220. A descriptor is included in all XML object documents to identify the XML DTD that was used to create that version of the document. The service proxy 220 may use this descriptor to determine how to handle the XML object document.

An exemplary XML document that describes a movie on demand service object 240 is defined below:

<?xml version=“1.0”?>
<!DOCTYPE MODServer SYSTEM “http://serviceproxy/
xmldb/MODserver.dtd”
>
<MODServer

Name=“MainServer”>
<Status

AdminStatus=“InService”
OperationalStatus=“InService”
StatusDate=“01012000”
StatusTime=“01:23:41”

</Status>
<Configuration

ServiceGroup=“DowntownSG1”
ServiceGroup=“DowntownSG2”
ServiceGroup=“NorthBurbs”

</Configuration>
<Verbs

Verb=“AddObject”
Verb=“DeleteObject”
Verb=“FindObject”
Verb=“PlayObject”
Verb=“GetStatus”
Verb=“SetAdminStatus”

</Verbs>
<Events

Event=“ObjectChange”
Event=“StatusChange”
Event=“ObjectPlay”

</Events>

</MODServer>

Events

An object may throw an event when instructed by the rules engine 230. This event may be used by the rules engine 230 to initiate the execution of other rules. Other processes in the system 200 may also register with the event processing server 250 to receive these events.

Typically, events are set using the particular messaging system provided by the operating platform. In one exemplary embodiment using an OpenStream.CORBA messaging system, these events are sent using the CORBA notification service. In another exemplary embodiment using the OpenStream.NET messaging system, the NET infrastructure is used to send the events. The event mechanism is portable to any platform that provides inter-process messaging capability, including without limitation the basic interrupt handling of a computer platform, the native signal handling in the UNIX Operating System, and high level language processors like JAVA and .NET.

Grouping

Grouping allows objects in the system 200 to be grouped under a single name. When this name is encountered by the rules engine 230, the action is applied to each entity in the group.

An exemplary XML document that describes a Group is defined below:

<?xml version=“1.0”?>
<!DOCTYPE Group SYSTEM “http://serviceproxy/xmldb/group.dtd” >
<Group>

Name=“AllMODServers”
ObjectType=“MODServer”
Object=“metroServer1”
Object=“metroServer2”
Object=“northwestServer1”
Object=“northeastServer1”
Object=“eastServer1”
Object=“westServer1”

</Group>End>
<Group>

Name=“mediumUseServers”
ObjectType=“MODServer”
Object=“headendServer1”
Object=“headendServer2”
Object=“headendServer3”
Object=“southRegionServer”
Object=“northRegionServer”

</Group>
<Group>

Name=“DCIIServers”
ObjectType=“MODServer”
Group=“mediumUseservers”
Object=“headendServer3”

</Group>
<Group>

Name=“modApps”
ObjectType=“MODApp”
Object=“modAppServer”
Object=“tvGuideServer”
Object=“testAppServer”

</Group>

All objects in a group must belong to the same object type. A group may also comprise other groups as long as the other groups are of the same object type as the group in which it is included.

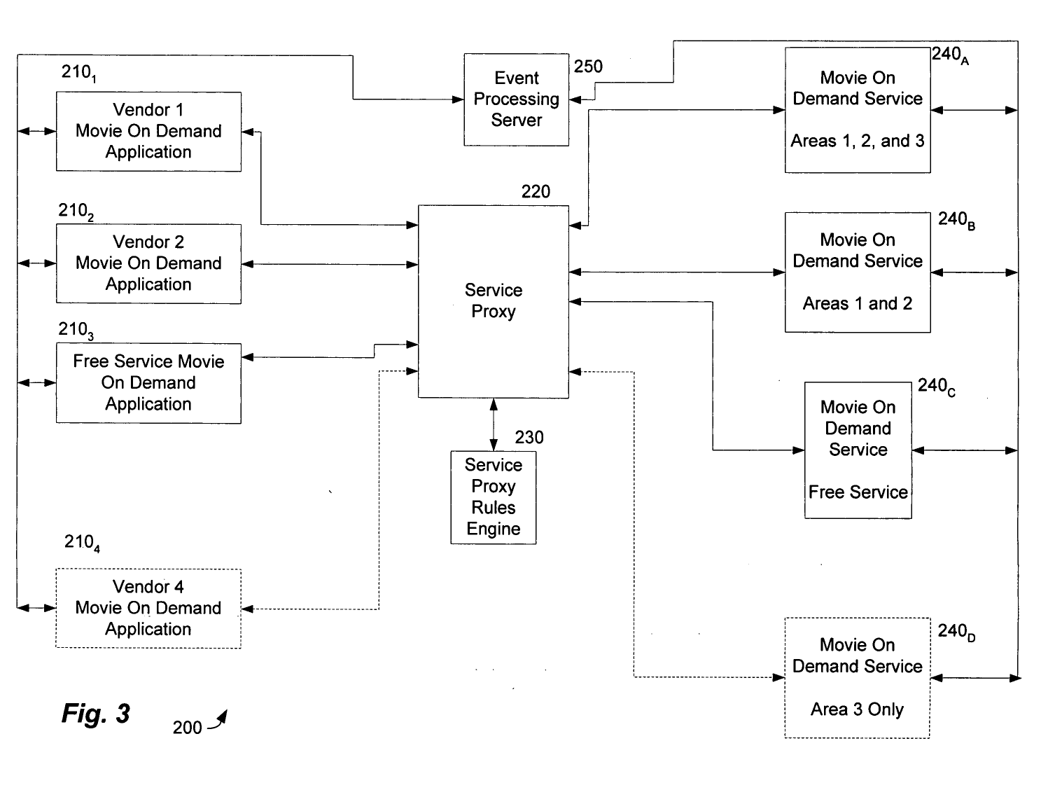

FIG. 3 is a block diagram illustrating an exemplary system 200 for streaming movies to a cable subscriber using a service proxy 220. In one exemplary embodiment of the present invention, a cable subscriber requests to view a movie on demand. The request is in the form of a session object and comprises the content request and subscriber information.

A movie on demand application 210₁, 210₂, 210₃, 210₄ receives the request and schedules the streaming of the movie to the cable subscriber. For example, the movie on demand application 210₁ sends a request to the service proxy 220 to stream a movie to a subscriber. Upon receiving the request, the service proxy 220 uses a rules engine 230 to determine which movie on demand service 240_{A}, 240_{B}, 240_{C}, 240_{D} to use to stream the movie to the cable subscriber. For example, the service proxy 220 may use the rules engine 230 to determine which movie on demand service 240_{A}, 240_{B}, 240_{C}, 240_{D} is available to stream the movie to the subscriber, which movie on demand service 240_{A}, 240_{B}, 240_{C}, 240_{D} is the cheapest or most efficient service to use to stream the movie to the subscriber, or which movie on demand service 240_{A}, 240_{B}, 240_{C}, 240_{D} is located in the closest proximity to the cable subscriber.

Once the subscriber requests to view movie on demand content, an application in the system 200 invokes the PlayContentRule. In one exemplary embodiment, the PlayContentRule is invoked by a movie on demand application 210₁. When invoked, the PlayContentRule determines the best location of the requested content based on the location of the set top box and the connectivity between certain components of the system 200, including, for example, content stores, video pumps, and network routing. Upon determining the best location of the requested content, the PlayContentRule sets up a route between the content and the set top box, reserving the required content server, video pump, and network resources. When the connection is fully established between the content and the set top box, the PlayContentRule starts the stream.

Although in one exemplary embodiment the PlayContentRule can be invoked by a movie on demand application 210₁, those skilled in the art recognize that, in other embodiments, the PlayContentRule can be invoked by any application in the system 200. For example, the PlayContentRule could be invoked by an ad insertion application to insert a targeted ad into broadcast content.

The rules engine 230 uses the information contained within the request to determine the best movie on demand service 240 that is available to deliver the content to the subscriber. To accomplish this task the rules engine 230 can employ the use of the following rule:

<?xml version=“1.0”?>
<!DOCTYPE ServiceProxyRule SYSTEM
“http://svcproxy/xmldb/svcproxyrule.dtd”>
<ServiceProxyRule>

Name=“PlayContentRule”
<Event

Object=“Content”
Event=“Play”

</Event>
<Action

Name=SelectServer
Object=AllMODServers
Verb=Filter(Server.Asset.IdList Includes Session.AssetId)
If (Result.Count = 0)

Action=Fail(100)

End
Verb=Filter(Server.SvcGrpList Includes Session.SvcGrp)
If (Result.Count = 0)

Action=Fail(101)

End
Verb=Filter(Server.AvailBandwidth => Server.Asset.Bandwidth)
If (Result.Count = 0)

Action=Fail(102)

End
Verb=Sort(Server.AvailBandwidth Descending)
Verb=Filter(Server.Asset.Encoding=
Session.Equipment.Encoding)
If (Result.Count = 0)

Action=Fail(103)

End
If (Filter(Server.SvcGrp.Connection.Type = “ASI”))

Verb=Server.Play(Session)
Action=Pass(0)

Else If (Filter(Server.SvcGrp.Connection.Type=“IP”))

If(Filter(Server.SvcGrp.Connection.AvailBandwidth =>

Server.Asset.Bandwidth))

Verb=Server.Play(Session)
Action=Pass(0)

Else

Action=Fail(104)

Else

Action=Fail(105)

End

</Action>
<Action

Name=Fail
Argument=Reason
Verb=Session.Fail(Reason)
ThrowEvent=“PlayContentRule.Fail(Reason)”

</Action>
<Action

Name=Pass
Argument=Reason
Verb=Session.Pass(Reason)
ThrowEvent=“PlayContentRule.Pass(Reason)”

</Action>

</ServiceProxyRule>

In the aforementioned exemplary ServiceProxyRule, the rules engine 230 processes the SelectServer action first since it is the first action in the rule. The “AllMODServers” Object instructs the rules engine 230 to run the action against the MOD Service Group that contains the following movie on demand services 240, as previously defined: metroServer1, metroServer2, northwestServer1, northeastServer1, eastServer1, and westServer1.

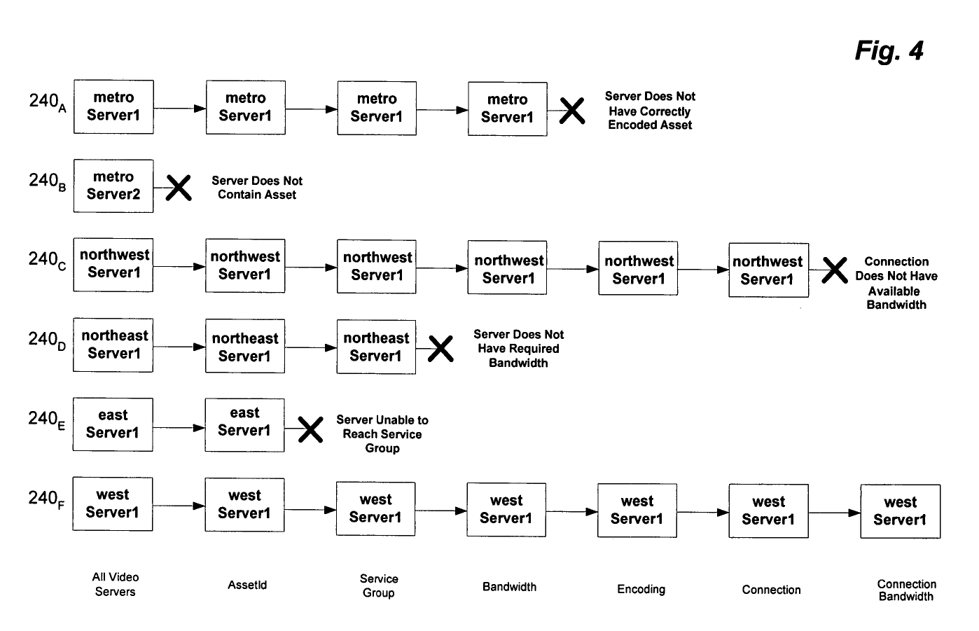

Referring now to FIG. 4, FIG. 4 is a block diagram illustrating the exemplary process by which the rules engine 230 selects which movie on demand service 240 should be used upon executing the exemplary ServiceProxyRule. The rules engine 230 next performs the filtering action to determine on which movie on demand services 240 the requested content is stored. Upon the rules engine 230 executing the filtering action for the specific AssetId, metroServer2 240_{B} is ruled out during the filtering process because it does not have the content that is being requested by the subscriber.

Next, the rules engine 230 executes the filtering action to determine which movie on demand services 240 can service the set top box of the subscriber that has issued the request. Upon the rules engine 230 executing the filtering for the Service Group, eastServer1 240_{E} is ruled out during the filtering process because it is not able to reach the set top box (i.e., the subscriber) that has requested the content.

Next, the rules engine 230 executes the filtering action to determine which movie on demand services 240 have a sufficient amount of bandwidth to deliver the requested content. Upon the rules engine 230 executing the filtering for bandwidth, northeastServer1 240_{D} is ruled out because it does not have sufficient bandwidth to deliver the requested content.

Next, the rules engine 230 executes the sort operation. The sort operation orders the remaining objects such that the service objects with the most available bandwidth are listed first. This allows for load balancing across services 240. As is recognized by those skilled in the art, more complex sort operations may be used to order the remaining objects according to other criteria.

Next, the rules engine 230 executes the encoding filter to determine which movie on demand services 240 have the proper encoding of the requested asset. Upon the rules engine 230 executing the encoding filter, the rules engine 230 eliminates metroServer1 240_{A} because it is not able to deliver the requested content to the specific set top box type requesting the session because the asset is not properly encoded for that set top box. As is understood by those skilled in the art, a service 240 may contain different encodings of the same content (Pre-Encrypted, Clear, MPEG-2, Windows Media Player, etc.).

As is illustrated in the exemplary ServiceProxyRule, the rules engine 320 supports branching using the if/then/else construct. In the next operation, the first filter determines if any of the remaining movie on demand services 240 use an ASI connection. In an actual implementation, this means that the movie on demand services 240 are directly connected to the service group. Therefore, no network bandwidth is required to deliver the session. If there are services 240 that are directly connected, then the first service in the sorted list is used. In this example, neither of the remaining services 240_{C}, 240_{F} is directly connected to the service group. Those skilled in the art recognize that a service 240 may be directly connected to one or more service groups and at the same time be connected to other service groups through a network.

The rules engine 230 then tests the remaining services 240_{C}, 240_{F} to determine if any of them are connected to the Service Group over an IP connection. While in a typical network, services are connected using either ASI or IP, this test is included to demonstrate the if/then/else function of the rules engine 230. In the example, none of the remaining services are using ASI, so they must have IP connectivity.

The rule tests the remaining services that have IP connectivity to the service group to determine if there is sufficient bandwidth on the connection between any of the services 240 and the service group to deliver the requested content. The rule takes the first service in the list regardless of the sorting order and uses it to play out the content. Upon the rules engine 230 executing the filtering for available bandwidth, northwestServer1 240_{C} is ruled out because it does not have sufficient bandwidth available to deliver the requested content. Thus, upon executing the ServiceProxyRule, the rules engine 230 determines that westServer1 240_{F} should be used to deliver content to the requesting subscriber.

In this exemplary embodiment, the Pass and Fail Actions are never executed as an in-line action since each of the results of the “if” construct specifically jump to an action. It is possible that an action may end without a jump to another action in which case the next action in the rule, if present, will be executed.

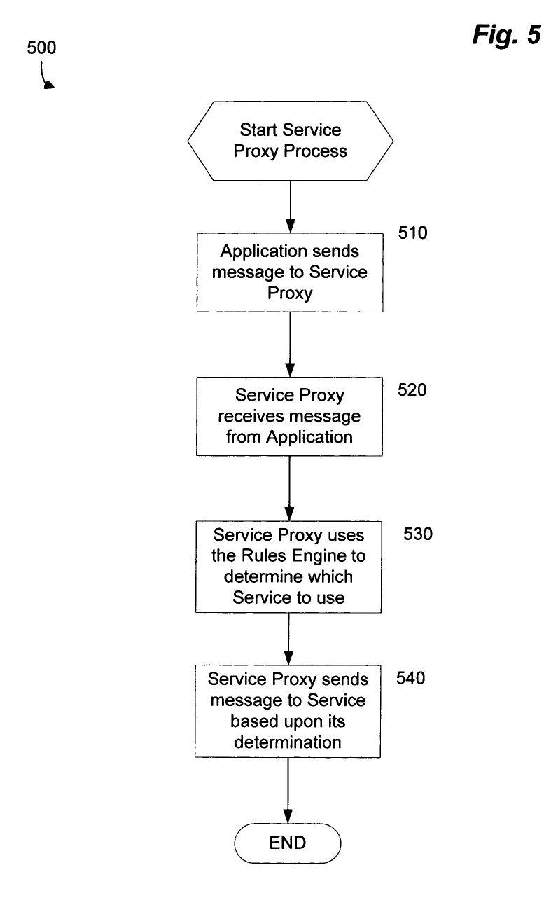

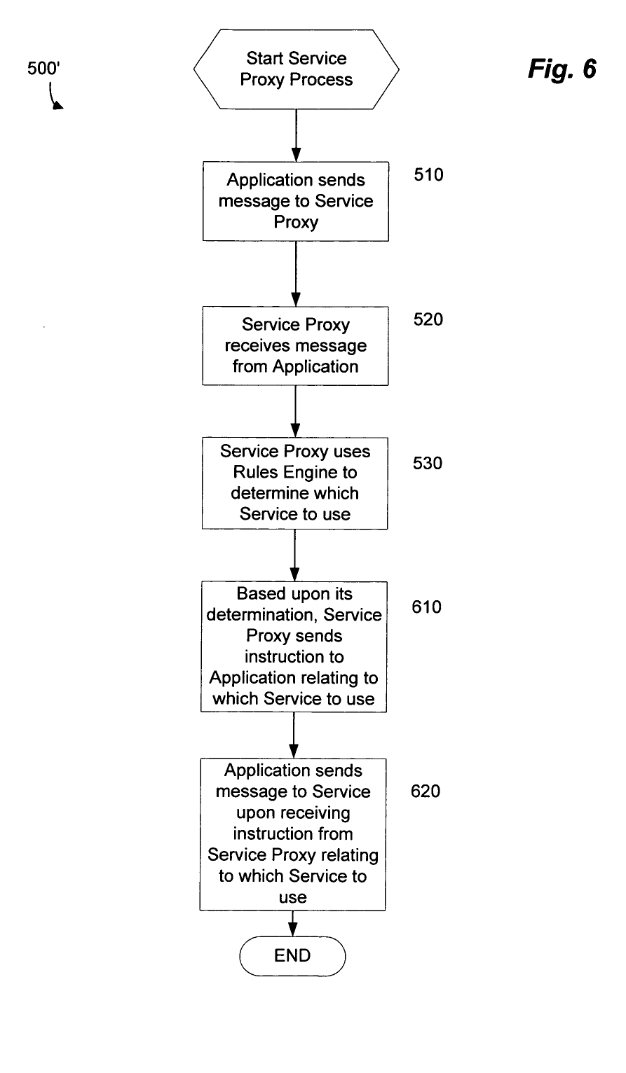

Certain steps in the processes described below in FIGS. 5 through 6 must naturally precede others for the present invention to function as described. However, the present invention is not limited to the order of the steps described, if such order or sequence does not alter the functionality of the present invention. It is recognized that some steps may be performed before or after other steps without departing from the scope and the spirit of the present invention.

FIG. 5 is a logic flow diagram illustrating an exemplary process 500 for streaming a movie to a cable subscriber using a service proxy 220. Step 510 is the first step in the exemplary process 500 of FIG. 5.

In step 510, a movie on demand application 210 sends a message to the service proxy 220 to stream a service to a cable subscriber. In step 520, the service proxy 220 receives the message from the application 210. In step 530, the service proxy 220 uses a rules engine 230 to determine which service 240 to use to stream the service to the cable subscriber. In step 540, the service proxy 220 sends a message to the service 240 based upon its determination.

FIG. 6 is a logic flow diagram illustrating an exemplary process 500′ for streaming a service to a cable subscriber. Step 510 is the first step in the exemplary process 500′ of FIG. 6.

In step 510, the application 210 sends a message to the service proxy 220 to stream a service to a cable subscriber. In step 520, the service proxy 220 receives the message from the application 210. In step 530, the service proxy 220 uses a rules engine 230 to determine which service 240 to use to stream the service to the cable subscriber. In step 610, the service proxy 220 sends an instruction to the application 210 relating to which service 240 to use based upon its determination. In step 620, the application 210 sends a message to the service 240 upon receiving an instruction from the service proxy 220 relating to which service 240 to use.

Those skilled in the art will appreciate that the exemplary system 200 is easily scalable to meet the needs of subscribers. For example, the system 200 can easily be scaled to add additional client applications 210, services 240, and business logic or rules because only the service proxy 220 and the service proxy rules engine 230 would need to be modified to recognize the new components or rules.

Additionally, those skilled in the art will appreciate that the exemplary system 200 and method allows multi-vendor applications and services to be integrated easily and efficiently without significant engineering effort or expense. For example, if components or rules are subsequently added or deleted from the system 200, only the service proxy 220 and the service proxy rules engine 230 would need to be modified to recognize the changes in the components or rules.

Finally, those skilled in the art will appreciate that the exemplary system 200 and method is efficient in allocating system resources among multi-vendor components, that it minimizes manual intervention, and that it promotes the efficient use of each resource. For example, the service proxy 220 and the service proxy rules engine 230 can manage and allocate system resources on behalf of the multi-vendor components through a set of rules implemented by the rules engine 230.

It should be understood that the foregoing relates only to the illustrative embodiments of the present invention, and that numerous changes may be made therein without departing from the scope and spirit of the invention as defined by the following claims.

1. A distributed and scalable digital asset system, comprising:
a plurality of services, operative to execute a function in response to receiving a message to execute the function;
at least one client application, operative to issue the message to execute the function; and
a service proxy, functionally coupled to the client application and the plurality of services, operative to receive the message from the client application and to identify a select one of the plurality of services to execute the function in accordance with at least one rule.

2. The distributed and scalable digital asset system of claim 1, wherein the service proxy is operative to send the message to the select service upon identifying the select service in accordance with the rule.

3. The distributed and scalable digital asset system of claim 1, wherein the service proxy is operative to send the identity of the select service to the client application.

4. The distributed and scalable digital asset system of claim 3, wherein the client application is operative to send the message to the select service upon receiving the identity of the select service from the service proxy.

5. The distributed and scalable digital asset system of claim 1, wherein the rule comprises at least one of an object and a verb.

6. The distributed and scalable digital asset system of claim 5, wherein the object describes a component of the system.

7. The distributed and scalable digital asset system of claim 5, wherein the verb is an operation that can be performed on the object by the service proxy.

8. A method of managing a plurality of services in a distributed network environment, comprising the steps of:
receiving a message to execute a function;
responsive to receiving the message, identifying a select one of the plurality of services to execute the function in accordance with at least one rule to assist in the identification of the select service; and
sending the message to the select service upon identifying the select service in accordance with the rule.

9. The method of claim 8, wherein the rule comprises an object that describes a component of the distributed network environment.

10. The method of claim 9, wherein the rule comprises a verb that comprises at least one operation that can be performed on the object.

11. The method of claim 8, wherein the rule assists in the identification of the select service that can execute the function most cost-efficiently.

12. The method of claim 8, wherein the rule assists in the identification of the select service that is available to execute the function.

13. The method of claim 8, wherein the rule assists in the identification of the select service that is available to execute the function and that can execute the function most cost-efficiently.

14. A method of managing a plurality of services in a distributed network environment, comprising the steps of:
receiving a message from a client application requesting that a function be executed;
responsive to receiving the message, identifying a select one of the plurality of services to execute the function using at least one rule to assist in the identification of the select service; and
sending an instruction to the client application identifying the select service to be used to execute the function.

15. The method of claim 14, comprising the step of sending the message from the client application to the select service in response to receiving the instruction.

16. The method of claim 14, wherein the rule comprises an object that describes a component of the distributed network environment.

17. The method of claim 16, wherein the rule comprises a verb that comprises at least one operation that can be performed on the object.

18. The method of claim 14, wherein the rule assists in the identification of the select service that can execute the function most cost-efficiently.

19. The method of claim 14, wherein the rule assists in the identification of the select service that is available to execute the function.

20. A distributed digital asset system, comprising:
a plurality of services, operative to facilitate the distribution of a digital asset to a subscriber in response to receiving a message to distribute the digital asset to the subscriber;
a client application, operative to issue the message to distribute the digital asset; and
a service proxy, functionally coupled to the client application and the plurality of services, operative to receive the message from the client application and to identify using at least one rule a select one of the plurality of services to distribute the digital asset.

21. The distributed digital asset system of claim 20, wherein the service proxy further comprises a rules engine, operative to execute the rule comprising at least one of an object and a verb.

22. The distributed digital asset system of claim 21, wherein the object describes a component of the system.

23. The distributed digital asset system of claim 21, wherein the verb is an operation that can be performed on the object by the rules engine.

24. The distributed digital asset system of claim 20, wherein the service proxy is operative to identify the select service based upon whether the select service is available.

25. The distributed digital asset system of claim 20, wherein the service proxy is operative to identify the select service that can distribute the digital asset to the subscriber in the most cost efficient manner.

26. The distributed digital asset system of claim 20, wherein the service proxy is operative to identify the select service based upon the digital asset to be delivered to the subscriber.

27. The distributed digital asset system of claim 20, wherein the service proxy is operative to send the message to the select service upon identifying the select service.

28. The distributed digital asset system of claim 20, wherein the service proxy is operative to send the identity of the select service to the client application upon identifying the select service.

29. The distributed digital asset system of claim 28, wherein the client application is operative to send the message to the select service upon receiving the identity of the select service from the service proxy.

30. The distributed digital asset system of claim 20, wherein the select service is operative to distribute the digital asset to the subscriber upon receiving the message.
